(19) United States
(12) Patent Application Publication
(10) Pub. No.: US 2012/0257041 A1
(43) Pub. Date: Oct. 11, 2012

(54) METHOD FOR DEFECT INSPECTION AND APPARATUS FOR DEFECT INSPECTION

(76) Inventors: Ryo Nakagaki, Kawasaki (JP); Minoru Harada, Fujisawa (JP); Takehiro Hirai, Ushiku (JP); Yuji Takagi, Kamakura (JP)

(21) Appl. No.: 13/513,258

(22) PCT Filed: Nov. 22, 2010
(86) PCT No.: PCT/JP2010/070819

§ 371 Date: Jun. 29, 2012

(30) Foreign Application Priority Data
Dec. 3, 2009 (JP) 2009-275647

(51) Int. Cl. H04N 7/18

(52) U.S. Cl. 348/80; 348/E07.085

(57) ABSTRACT

Provided is a technique for a wafer inspection conducted by simple operation, which is useful even when the inspection covers a variety of items and the inspection items are changed frequently with time like in a start-up period of a semi-conductor process. According to the technique, inspection images are collected, and then a template is prepared from the inspection images. A plurality of regions are defined on the template, and inspection methods and output indexes are registered in correspondence with the respective regions. In the inspection, by reference to the template images corresponding to the derived inspection images, the inspection is conducted based on the inspection information registered therein and the quantitative output levels are calculated.

### TECHNICAL FIELD

The present invention relates to a defect inspection method and an inspection apparatus that inspect various defects occurring in the manufacturing process steps of semiconductor wafers or the like.

### BACKGROUND ART

In the manufacture of semiconductor wafers, it is important to secure profits that the manufacture process is quickly started and shifted early to a mass production system in high yields.

To this end, various inspection and measurement apparatuses are introduced into manufacturing lines. In a process ramp-up stage, for the purpose of early determining process conditions that can form desired circuit patterns, the following is sometimes performed. For example, process conditions are changed intentionally to prepare a plurality of wafers or chips, and the wafers or chips are inspected to determine process conditions based on the inspected result. On the other hand, wafer inspection in mass production stages is performed for the purpose of monitoring processes. Namely, a wafer is randomly sampled and inspected for checking whether defects occur on the surface of the wafer, or faulty circuit patterns are observed in circuit patterns formed on the wafer surface, for example. As a result of inspection, in the case of detecting defects or faulty circuit patterns, the cause is investigated and necessary measures are taken.

For a representative inspection apparatus for use in the process ramp-upp stage or the mass production stages as described above, there is an optical wafer inspection apparatus. For example, Patent Literature 1 (Japanese Patent Application Laid-Open Publication No. 2000-97869) discloses a technique in which the optical image of a wafer surface is imaged by bright field optical system and the optical image is compared with the image of a non-defective item portion (the image of an adjacent chip, for example) for inspecting defects. However, this optical inspection apparatus is affected by the illumination wavelength and the resolution limit of the acquired image is about a few hundred nanometers. Therefore, as for defects in the order of a few nanometers on a wafer, only the presence or absence of these defects can be detected. In the case of analyzing defects in detail, a defect review apparatus of higher imaging resolution, for example, is separately necessary.

For wafer inspection apparatuses other than optical ones, there is also known an SEM (Scanning Electron Microscope) inspection apparatus. In this apparatus, an electron beam is applied to an inspection portion on a wafer, secondary electrons or the like generated from the inspection portion are detected to acquire an image, and the acquired image is compared with the image of a non-defective item portion for inspection. The SEM inspection apparatus can enhance image resolution to the order of nanometers different from the optical inspection apparatus, and can also perform defect mode inspection to detect defects that cannot be revealed in an optical image such as a VC(voltage contrast) defect. Patent Literature 2 (Japanese Patent Application Laid-Open Publication No. 2003-106829) describes a wafer inspection method by an SEM wafer inspection apparatus like this.

These two examples described above are apparatuses in which the optical image or SEM image of a wafer surface is acquired and the image is compared with a non-defective item portion for inspection. In addition to these apparatuses, a pattern measuring apparatus is also used for wafer inspection. As an example of this apparatus, there is known a CDSEM that is an SEM pattern measuring apparatus. The CDSEM is an apparatus for use in managing the patterning processes of semiconductors particularly, and can measure the line width of a circuit pattern on a wafer in the measurement accuracy of subnanometers. Locations to be measured, template shapes of a circuit pattern to be measured (line patterns, hole patterns, and the like), and measurement items (line width, line pitch, hole pattern diameters, and the like), and so on are registered beforehand in a condition setting file called a recipe. In measurement, an electron beam is applied to measurement locations, and secondary electrons or the like generated from the locations are detected to acquire the image of a circuit pattern to be a measurement subject. This pattern image is then searched for a pattern to be measured by a pattern matching method, and a processing algorithm to calculate set measurement items is applied to the searched pattern for measuring the pattern. Patent Literature 3 (Japanese Patent Application Laid-Open Publication No. 2003-59441) describes a pattern measuring method in this CDSEM.

### CITATION LIST

### Patent Literature

Patent Literature 1: Japanese Patent Application Laid-Open Publication No. 2000-97869
Patent Literature 2: Japanese Patent Application Laid-Open Publication No. 2003-106829
Patent Literature 3: Japanese Patent Application Laid-Open Publication No. 2003-59441

### SUMMARY OF INVENTION

### Technical Problem

Shrinking in the semiconductor processes is being continuously engaged, and the complexity of manufacturing processes and the diversification of materials are advancing in the consequence. Moreover, in association with process-shrinking, systematic defects are increasing, which are caused as by the shapes and layout of circuit patterns, not random defects such as foreign particle or scratches on wafer surface. As a result, inspection items are diversified in manufacturing devices. The inspection items are the detection and quantification of various failures and defects such as misalignment of pattern s and random defects including pattern defects, material-related defect, pattern dimension failure, VC defect, foreign particle, and scratches, for example. FIGS. 3, 4, and 5 schematically illustrate exemplary defect types occurring on a wafer and inspection items. FIG. 3(a) schematically illustrates a line-shaped circuit pattern 301 (in a non-defective state). FIG. 3(b) illustrates an example of a dark-spot defect 311 on patterns 302 and 303 caused by material failure. FIG. 3(c) illustrates an exemplary faulty shape that adjacent patterns 304 and 305 are joined to each other with a defect 312. On the other hand, FIG. 3(d) illustrates an example that although the shape of a pattern 306 is normal, the brightness of the pattern 306 is faulty. In the case where an image is imaged by an SEM, electrical conduction failure is revealed as difference in brightness on the image. These defects are also called VC defect. FIG. 3(e) illustrates an example that a pattern 307 is narrowed. Inspection items for these defects are the determination of defects (the determination of the presence or absence of defects), and the quantification of the levels of defects (for example, the number of defects in FIG. 3(b), the brightness of vc defects in an image in FIG. 3(d), a pattern width W in FIG. 3(e), and so on), for example.

Moreover, FIG. 4 illustrates exemplary hole patterns. FIG. 4(a) illustrates a non-defective pattern 401. FIG. 4(b) illustrates an example that a dark point defect 411 occurs in holes caused by material growth failure. FIG. 4(c) illustrates an example that the brightness of a hole portion is revealed as voltage contrast due to conduction failures 412 of the hole portion. FIG. 4(d) illustrates an example that locations 413 have no hole or a hole 414 is smaller than a predetermined shape due to processing failure in forming holes. FIG. 4(e) illustrates a faulty shape 415 that a hole dimension is changed as compared with the dimension of a non-defective item (here, a hole diameter W in the vertical direction).

Furthermore, FIG. 5 illustrates exemplary defects in the process step of observing a plurality of layers different from defects in FIGS. 3 and 4. FIG. 5(a) is an example of a non-defective pattern that two upper layer patterns 502 are formed on an under layer pattern 501. FIG. 5(b) is an example that dark defects 511 are formed on upper layer patterns 503. FIG. 5(c) illustrates a pattern defect 512 in forming an under layer pattern 504. FIG. 5(d) illustrates a pattern defect 513 of an upper layer pattern (on the right side) 513. FIG. 5(e) illustrates an exemplary misalignment (denoted as W) between an upper layer pattern 506 and an under layer pattern 507. Defect determination and quantification are inspection items also for these defects illustrated in FIGS. 4 and 5. The cases described here are examples, and various defects occur in manufacturing

processes. In addition, it is predicted that the development of three-dimensional devices called a Fin FET, for example, will be started in full scale in future, and it is likely that new defects occur, which do not exist in the past, and inspection items are added in association with the new defects.

Under these situations, the load of inspection operations in the ramp-up period of the manufacturing processes is increased particularly. It is often difficult to predict that what defects will occur in the ramp-up period of the processes. Therefore, it is necessary to repeat preparing wafers, which process conditions are changed, inspection, and taking measures. Defects of interest, that is, inspection items might be frequently changed over time as the development of processes proceeds. Moreover, in the manufacture of semiconductor wafers including a large number of manufacturing process steps (device isolation process steps, gate forming process steps, copper wiring pattern forming process steps, and the like), it is natural that inspection items are varied between the manufacturing process steps. Therefore, in the process ramp-up stage, it is necessary to provide techniques that efficiently perform inspection and analysis even in a state in which it is uncertain what defects occur, and it is increasingly important to provide techniques that easily meet the modification, changes, and addition of inspection items.

With the process-shrinking, when it is also taken into account that the defect size to be critical for devices is a few nanometers or less, it is predicted that SEM inspection apparatuses and techniques will be increasingly expected more than ever in future. However, the present SEM wafer inspection apparatuses and CDSEMs only have functions to inspect defects and to measure patterns, and for the schemes, there are only provided an inspection function to compare an inspection image with a non-defective item image for inspecting defects, and a function to measure a pattern in the same shape as the shape of a circuit pattern registered beforehand (a line pattern or a hole pattern) for measuring patterns. Moreover, in these conventional apparatuses, it is assumed that a single inspection item such as inspecting defects or measuring pattern dimensions is performed on the acquired image. It is impossible to implement defect inspection and pattern misalignment measurement, for example, on a single image simultaneously. As described above, in the conventional techniques, it is impossible to easily meet efficient defect analysis and the modification, changes, and addition of inspection items, for example, in a state in which it is uncertain what defects occur.

### Solution to Problem

In order to address the problems described above, in the present invention, in a method in which an SEM image of an inspection location on a semiconductor wafer, which is a subject to be inspected, is acquired and this image is processed to inspect the subject to be inspected, the method includes: imaging the subject to be inspected to collect inspection images; creating a template from the collected images; setting a plurality of partial regions on this template; associating and storing an inspection method and an output index value with the plurality of individual partial regions; acquiring an inspection image that an inspection location on the subject to be inspected is imaged; detecting positions of the partial regions set on the template in the acquired inspection image; and performing the inspection method in the detected partial regions to calculate an output index, the inspection method being stored in association with the detected partial regions.

Moreover, in order to address the problems described above, in the present invention, in a method in which an SEM image of an inspection location on a semiconductor wafer, which is a subject to be inspected, is acquired and this image is processed to inspect the subject to be inspected, the method includes: setting a plurality of partial regions on a template associated with an inspection location; associating an inspection method and an output index value with the plurality of individual set partial regions for storage; acquiring an inspection image that an inspection location on the subject to be inspected is imaged; detecting the position of the partial region set on the template in the acquired inspection image; and performing any one of inspection methods including a comparison inspection method, a pattern matching method, and a segmentation method in the detected partial regions to calculate an output index, the inspection methods being stored in association with the partial region.

Furthermore, in order to address the problems described above, in the present invention, in a defect inspection apparatus that inspects an inspection location on a semiconductor wafer using an image acquired by imaging the inspection location using an SEM, the apparatus includes: an image acquiring unit that acquires an SEM image at the inspection location on the subject to be inspected; a storage unit that associates a template associated with the inspection location with location information about a plurality of partial regions defined on the template and information about an inspection method and an output index value set to the individual partial regions for storage; a unit that detects positions of the plurality of partial regions on the template in the inspection image of the subject to be inspected; an inspection processing unit that individually performs the inspection method in the detected partial regions to calculate an output index, the inspection method being stored in association with the detected partial regions; and a display unit that displays the processed result at the inspection process unit.

### Advantageous Effects of Invention

According to the present invention, it is possible to provide a wafer inspection technique that is applicable even in the case where inspection items and defect types occurring are uncertain, or in the case where inspection items are frequently changed over time.

### BRIEF DESCRIPTION OF DRAWINGS

FIG. 1 is a flowchart illustrating the flow of a defect inspection process according to a first embodiment.

FIG. 2 is a block diagram illustrating the schematic configuration of a defect inspection apparatus according to the first embodiment.

FIG. 3 is plan views of line patterns illustrating exemplary defects.

FIG. 4 is plan views of hole patterns illustrating exemplary defects.

FIG. 5 is plan views of multi-layer patterns illustrating exemplary defects.

FIG. 6 is illustrations depicting the flow of a process of extracting defects from a line pattern image.

FIG. 7 is diagrams illustrative of the flow of a process of extracting pattern shape feature values from the inspection image of hole patterns.

FIG. 8A is the template image of multi-layer patterns and enlarged diagrams of reference patterns.

FIG. 8B is diagrams illustrating the flow of a process of extracting edge positions from the inspection image of a multi-layer pattern.

FIG. 8C is a diagram illustrative of the relationship between a reference pattern signal waveform and an edge position in an inspection image.

FIG. 9 is diagrams illustrative of procedures to find a pattern width W of an upper layer from the image of a multi-layer pattern by a segmentation method.

FIG. 10 is diagrams illustrative of procedures to find a pattern width W of an upper layer from the image of a multi-layer pattern by a pattern matching method.

FIG. 11 is diagrams illustrative of procedures to extract a faulty shape from the image of hole patterns by an image comparison method.

FIG. 12 is diagrams illustrative of procedures to analyze pattern shapes by the pattern matching method.

FIG. 13 is a front view illustrating a display screen for setting an inspection region on a template image.

FIG. 14 is a front view illustrating a display screen for setting inspection conditions in the image comparison method.

FIG. 15 is a front view illustrating a display screen for setting inspection conditions in the segmentation method.

FIG. 16 is a front view illustrating a display screen for setting inspection conditions in the pattern matching method.

FIG. 17 is a diagram illustrating the data of inspection conditions for the individual inspection methods in a table format.

FIG. 18(a) is a template image in the first embodiment, FIG. 18(b) is a diagram of a template image illustrating a state in which inspection regions are set on an under layer pattern in the first embodiment, FIG. 18(c) is a diagram of a template image illustrating a state in which inspection regions are set in a region where an upper layer pattern overlaps with an under layer pattern in the first embodiment, and FIG. 18(d) is a diagram of a template image illustrating a state in which inspection regions are set in a region including the lower end portion of an upper layer pattern and an under layer pattern therearound in the first embodiment.

FIG. 19(a) is an inspection image in the first embodiment, FIG. 19(b) is a diagram of an inspection image illustrating a state in which inspection regions are set on an under layer pattern in the first embodiment, FIG. 19(c) is a diagram of an inspection image illustrating a state in which inspection regions are set in a region where an upper layer pattern overlaps with an under layer pattern in the first embodiment, and FIG. 19(d) is a diagram of an inspection image illustrating a state in which inspection regions are set in a region including the lower end portion of an upper layer pattern and an under layer pattern therearound in the first embodiment.

FIG. 20 is a front view illustrating a screen displaying inspected results according to the first embodiment.

FIG. 21 is a front view illustrating a screen displaying inspected results according to the first embodiment in a wafer map format.

FIG. 22 is a flowchart illustrating the flow of a process of creating a template image in defect inspection according to a second embodiment.

FIG. 23 is a flowchart illustrating the flow of an inspection process in defect inspection according to the second embodiment.

FIG. 24 is a template image according to a third embodiment.

FIG. 25(a) is a diagram of an alignment pattern and an image therearound in an inspection image according to the third embodiment, FIG. 25(b) is the image of an inspection region (1) in an inspection image according to the third embodiment, and FIG. 25(c) is the image of an inspection region (2) in an inspection image according to the third embodiment.

FIG. 26 is a flowchart illustrating the flow of a process of estimating a portion where a defect occurs or a portion where a defect tends to occur using the inspected results of an optical wafer inspection apparatus.

### DESCRIPTION OF EMBODIMENTS

In the present invention, in a method and an apparatus therefor that inspect, measure, or observe a defect on a sample using an SEM image of the sample acquired by imaging the sample using a scanning electron microscope (SEM), the method and the apparatus include: imaging the sample using the scanning electron microscope (SEM); aligning the acquired SEM image of the sample with a template image stored in a storage unit; setting an inspection region on the aligned SEM image using inspection region information stored in association with the template image; and processing the SEM image based on an inspection method selected in association with the inspection region information about the template image from a plurality of inspection methods and an inspection item set in association with the inspection region information to inspect, measure, or observe the set inspection region.

In the following, embodiments of the present invention will be described with reference to the drawings.

### First Embodiment

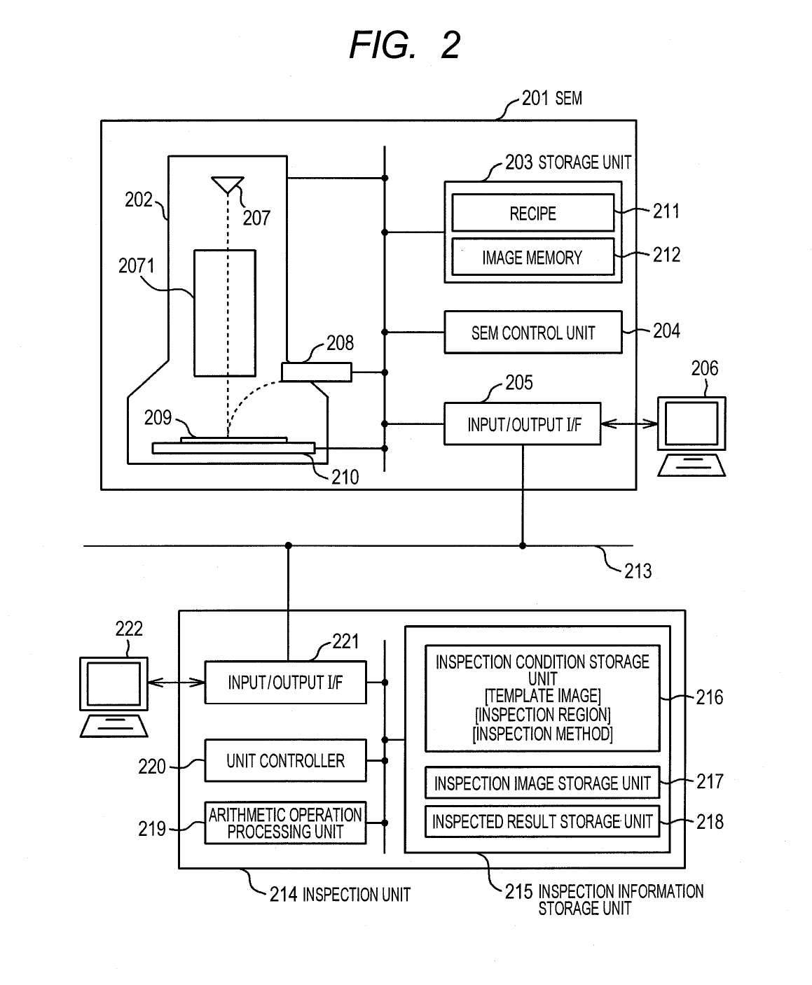

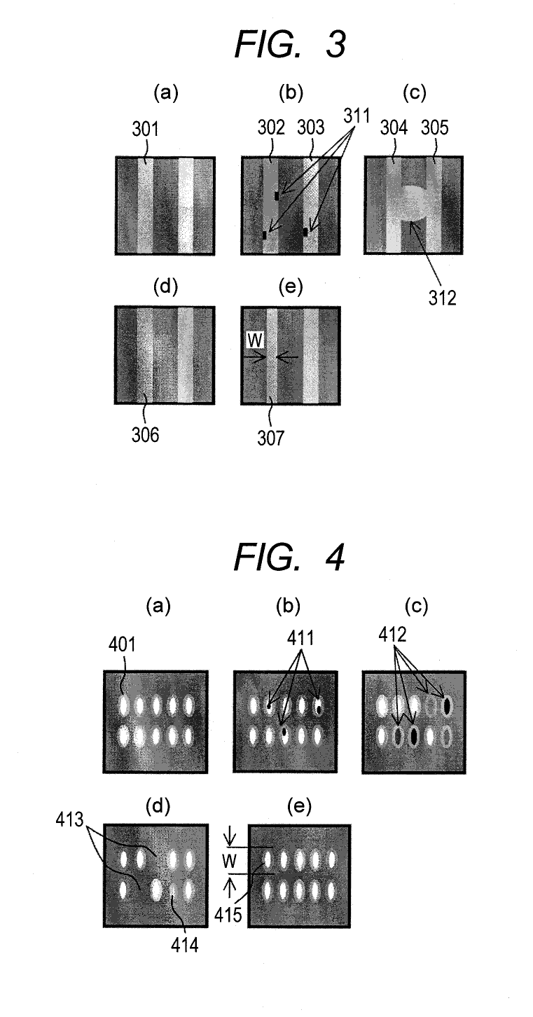

In the following, specific embodiments of a defect inspection method and a defect inspection apparatus according to the present invention will be described. FIG. 2 illustrates a block diagram depicting a defect inspection apparatus according to the present invention. This apparatus is configured in which an SEM 201 is connected to an inspection unit 214 through a communicating unit 213.

The SEM 201 is formed of an electro-optic system column 202, a storage unit 203, an SEM control unit 204, an input/output I/F 205, and an input/output terminal 206. Moreover, the electro-optic system column 202 is formed of a movable stage 210 on which a sample wafer 209 is placed, an electron source 207 that generates electrons, an electro-optic system 2071 that converges the electrons generated at the electron source 207 in a beam and applies and scans the beam onto a desired region on the sample wafer 209, a detector 208 that detects secondary electrons generated from the sample wafer, a deflector (not shown) that scans the electron beam on the sample wafer, an image generating unit (not shown) that digitally converts the intensity of the detected electrons for creating an image, and so on.

The storage unit 203 includes a recipe 211 that stores accelerating voltage, probe currents, imaging visual field size and the like, which are SEM imaging conditions, and an image memory 212 that stores acquired image data.

The SEM control unit 204 is a unit that controls processes such as acquiring images at SEM 201. The SEM control unit 204 makes instructions to move the movable stage 210 to move a predetermined inspection portion on the sample wafer 209 into an imaging visual field, to apply an electron beam onto the sample wafer 209, to detect generated electrons at the detector 208, to form an image of detected data, to store images in the image memory 212, and so on. An operator makes various instructions and specifies imaging conditions, for example, through the input/output terminal 206 formed of a keyboard, a mouse, a display, and the like.

On the other hand, the inspection unit 214 is a unit that performs an inspection process on SEM images. The inspection unit 214 is formed of a unit controller 220 that controls the inspection unit 214 overall, an arithmetic operation processing unit 219 that performs various image processes on images, an inspection information storage unit 215 that stores various items of information necessary for the inspection process, an input/output I/F 221 having an interface function to send and receive data with the SEM main body side, and an input/output terminal 222 that inputs the conditions of various processes performed at the inspection unit 214 and displays inspected results, for example. The inspection information storage unit 215 further includes an inspection condition storage unit 216 that stores template images necessary in the inspection process and information about inspection regions and inspection methods in association with the template images, an inspection image storage unit 217 that stores inspection images, and a unit 218 that stores inspected results. Next, a defect inspection method using the defect inspection apparatus illustrated in FIG. 2 will be described.

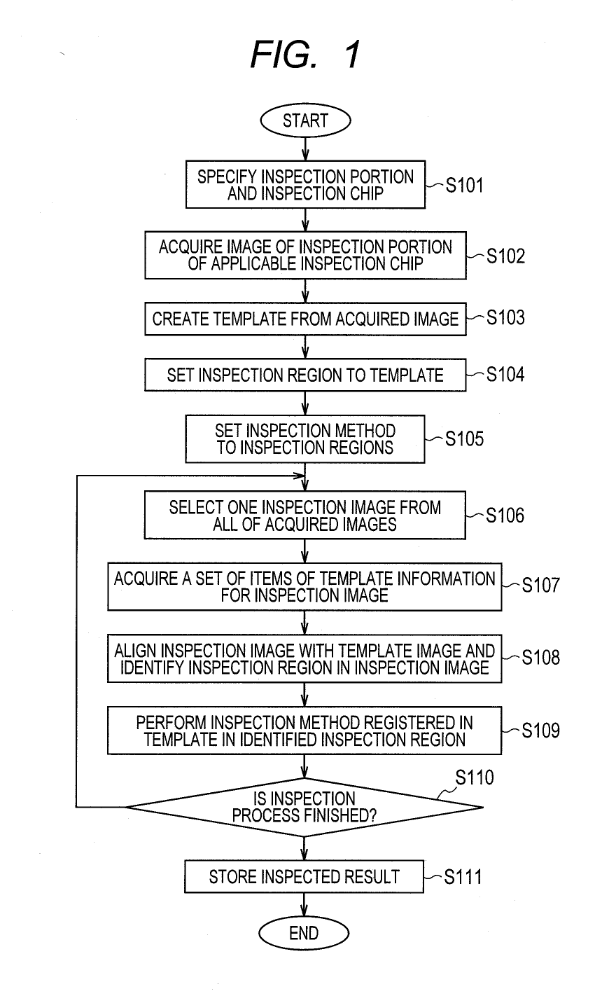

FIG. 1 illustrates the process flow of a defect inspection method according to the present invention. In the flow of processing, first, an inspection subject chip and an inspection portion in the chip are specified in a wafer to be an inspection subject (S101), the image of the inspection portion in this inspection chip is acquired (S102), and a template is created from the acquired image (S103). Subsequently, inspection regions are set on the template (S104), and an inspection method is set to the inspection regions (S105). Subsequently, one inspection image is selected from all the acquired images (S106), and a set of items of template information corresponding to the selected inspection image is acquired (S107).

Subsequently, the inspection image is aligned with the template image to identify an inspection region in the inspection image (S108), and the registered inspection method for the template is performed in the identified inspection region (S109). Steps S106 to S109 are repeated until inspection is finished, the inspected results are stored when finishing inspection (S111), and the process is ended.

Next, the detail of the steps will be described.

In semiconductor patterns, circuits are designed in the units called chips, and many these chips are arranged and formed on a wafer. The first object in Step S101 is to select a chip to be inspected from a large number of chips on a wafer. For example, if the object is to grasp a wafer in-plane tendency in the situations of defects occurring, it is sufficient to select inspection chips from a wafer at constant intervals. Moreover, if a wafer is a wafer that process conditions are changed for each chip as in an FEM (Focus Exposure Matrix) wafer, an inspection chip is freely selected and specified according to the purposes of inspection. Furthermore, the second object in Step S101 is to specify an inspection portion. The inspection portion means a location at which inspection is performed in a chip layout (that is, location information in a chip). In the general case, a single chip includes a plurality of pattern layouts different in shapes, pattern width, pattern density, and so on therein. The tendency of occurrence of defects is varied between pattern layouts (a portion with a narrow pattern width more tends to cause faulty shapes, for example), so that if a portion where a defect tends to occur is known, the portion is specified as an inspection portion to perform more efficient inspection.

For a method of predicting a location where a defect tends to occur, there is a method of utilizing a process simulator that simulates manufacture processes, for example. The process simulator is used to predict pattern shapes to be formed on a wafer from design data, and an inspection portion is specified from the predicted result.

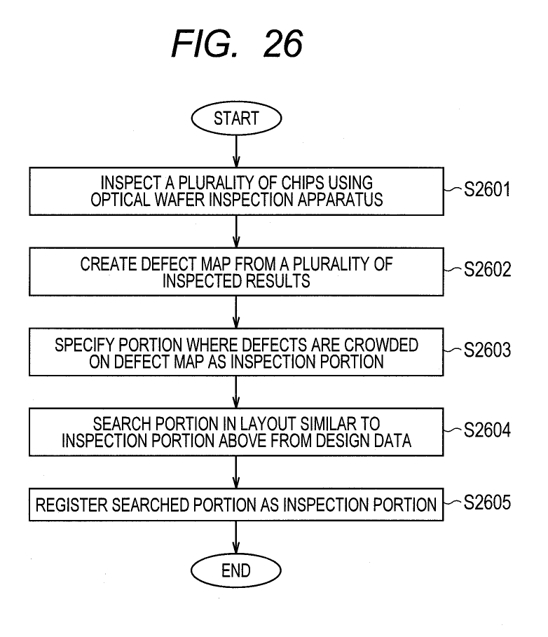

Moreover, for the other methods, it is also possible to use the inspected result of an optical wafer inspection apparatus (FIG. 26). The illumination wavelength of the optical wafer inspection apparatus is the order of a few hundred nanometers. When inspection is performed under the conditions that inspection sensitivity is increased in order to inspect a defect in a few nanometers, a pseudo defect such as a fabrication crossover of patterns is detected among true defects.

Therefore, as illustrated in a flowchart in FIG. 26, a portion where a defect occurs or a portion where a defect tends to occur is estimated from this inspected result. More specifically, a plurality of chips are inspected using the optical wafer inspection apparatus (S2601), and an overlay defect map is created from the obtained inspected results (S2602). The defect map is a map that the inspected result of a single chip is mapped at positions in the chip. The overlay defect map is a map that the defect maps of the inspected results of a plurality of inspections are overlaid with each other as a single map.

Since it is predicted that a large number of defects will occur at a location where a defect tends to occur in a chip in a plurality of inspected results, defects are to be crowded at such a location on the overlay defect map. On the other hand, it is likely that a pseudo defect is varied between being detected and undetected for every inspected result, and it is expected that pseudo defects are not crowded on the overlay map. Therefore, a portion where defects are crowded is specified as an inspection portion (S2603).

Moreover, in the case where the design data of circuit patterns can be utilized, a portion where the defect portion thus specified is similar to the circuit pattern shape on design is searched by analyzing design data (S2604), and the portion is specified and registered as a new inspection portion (S2605). In this search, if the data of an inspection subject layer as well as the design data of a plurality of layers below the inspection subject layer are used in analyzing design data, it is expected to further enhance the accuracy of searching the similar portion.

Furthermore, for a method of specifying the inspection portion, it is also considered that an inspection test pattern region is formed beforehand on a wafer and the region is specified as an inspection portion, for example, in addition to the method described above.

Specifying these inspection chips and inspection portions is inputted through the input/output terminal 222, information about specifying them is sent to the SEM 201 side, and the information is stored in the recipe 211. It is noted that in embodiments below, the case will be described where only one location is specified as an inspection portion in a chip. However, it is also of course possible to select a plurality of locations in different pattern layouts.

Subsequently, the wafer to be a subject is placed on the movable stage 210 of the SEM 201, and an inspection portion and an inspection chip are specified (S101). The image of the inspection portion in the specified inspection chip is acquired (S102).

Since the inspection portion is specified as coordinates in the chip, SEM images at the same coordinate in the different chips are acquired for every inspection subject chip in Step S102. The SEM control unit 204 reads, out of the recipe 211, a series of processes for acquiring this image, such as information including imaging positions and conditions in imaging, for example, (accelerating voltage, probe currents, visual field size, and so on, for example), moves the stage 210, applies and scans an electron beam, and acquires images, for example, for acquiring images. Moving the wafer stage and imaging are repeated to collect all the inspection images specified on the wafer. The acquired images are temporarily stored in the image memory 212, and transferred to the inspection image storage unit 217 through the communicating unit 213 and stored.

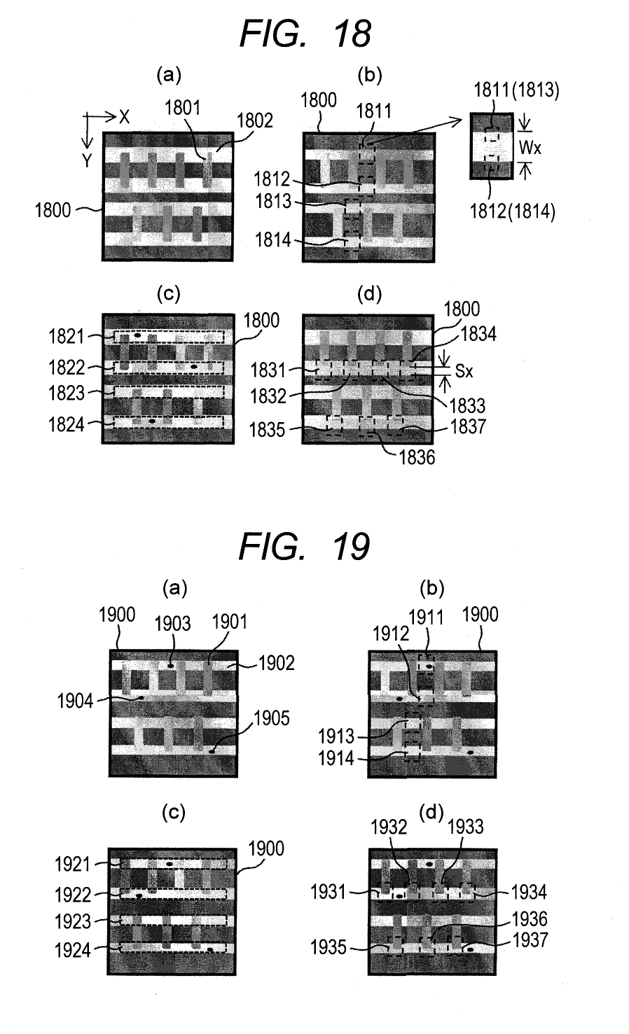

Subsequently, a template is created from the acquired images (S103). The template is a representative image of the inspection portion (a non-defective item image, for example). Namely, the template means an image that represents where and what pattern is to be formed in the visual field of the image. This template is formed by registering a single image specified by a user among the acquired image group. The collected image group includes images with a different number and different levels of defects due to a difference in process conditions, for example, although the images are acquired at the same location on design. Thus, it is possible to register an image the closest to the non-defective item as a template while visually observing the acquired images. It is noted that for the other methods of creating a template, such a method can be considered that a user specifies a plurality of images to form the average image of these images. FIG. 18(a) is an exemplary template in a multi-layer pattern process step. This template schematically illustrates the case where the template is formed of under layer patterns 1802 in lateral wiring patterns in the horizontal direction and upper layer patterns 1801 formed thereon.

Subsequently, inspection regions are specified on the template (S104), and an inspection method is individually set to the regions (S105). More specifically, a plurality of inspection regions are set on the template in FIG. 18(a), and any one of three inspection methods is set to each of the inspection regions.

In FIG. 18, (b), (c) and (d) are examples that a plurality of inspection regions are set on the template illustrated in (a) of FIG. 18. For explanation, the set regions are separately depicted in (b), (c), and (d) of FIG. 18. The criterion of separating these three diagrams is based on differences in inspection purposes (inspection items) as follows. Inspection regions in (b) of FIG. 18 are four rectangular regions 1811 to 1814 (depicted as dotted rectangles) individually set to four under layer patterns. In the explanation below, an inspection item in these inspection regions is to measure a pattern width (Wx). Inspection regions in (c) of FIG. 18 are four rectangular regions 1821 to 1824 (depicted as dotted rectangles) defined on four under layer patterns. An inspection item in these regions is to determine defects on the under layer patterns. Inspection regions in (d) of FIG. 18 are seven rectangular regions 1831 to 1837 (depicted as dotted rectangular regions) surrounding the lower end portion of an upper layer pattern and an under layer pattern overlapping therewith. An inspection item in these inspection regions is to measure a pattern shift value (Sx) between the upper layer pattern and the under layer pattern.

Subsequently, an inspection method is set to the set inspection regions (S105). In this embodiment, any one of three methods, the comparison of a defect image with a reference image (in the following, image comparison), the segmentation process of circuit patterns (in the following, segmentation), and reference pattern searching (in the following, pattern matching), are used for inspection methods. Since these processing algorithms are formed in modules and installed on the arithmetic operation processing unit 219 of the inspection unit 214, the content of the arithmetic operation processing unit 219 is modified to implement processes not limited to these three methods.

In the following, the three inspection methods will be described.

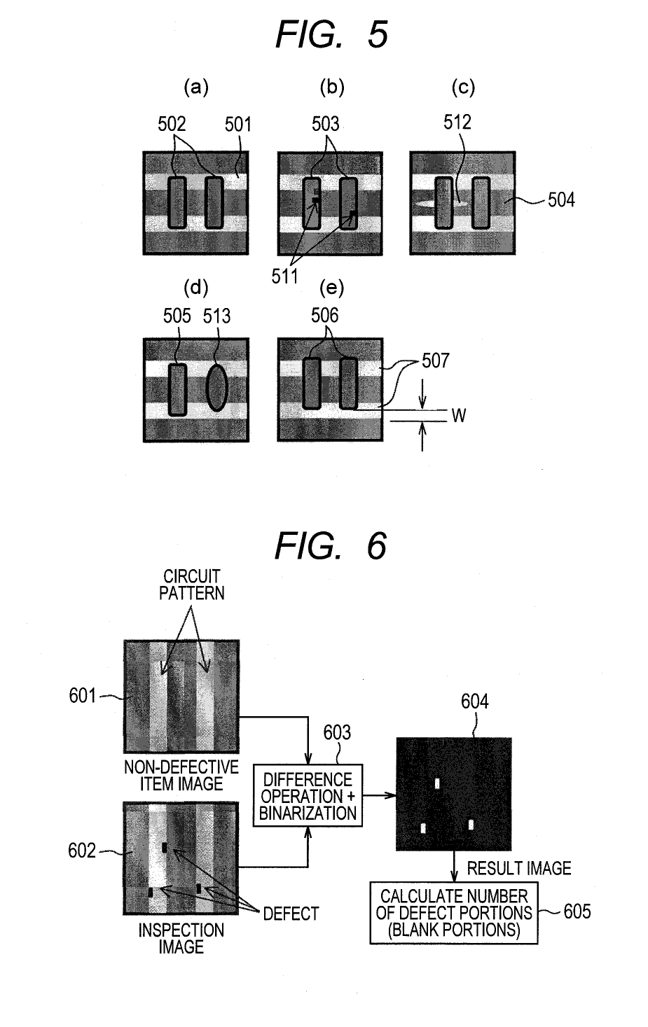

FIG. 6 illustrates the content of the image comparison method. This method is an inspection method in which a difference between an inspection image and a reference image (a non-defective item image) is calculated and defect information is acquired from the result. FIG. 6 illustrates a result image 604 that binarization 603 is performed on the arithmetic operation of a differential image between an inspection image 602 and a reference image (a non-defective item image) 601 at a predetermined threshold and a portion with a large gray scale value difference is expressed in a blank and a portion with a small gray scale value difference is expressed in dark between a defect image and a non-defective item image. On this result image, dark defects on circuit patterns are detected as three blank portions on the result image. The number of blank portions and the areas of the blank portions, for example, are calculated from this image to obtain defect information 605.

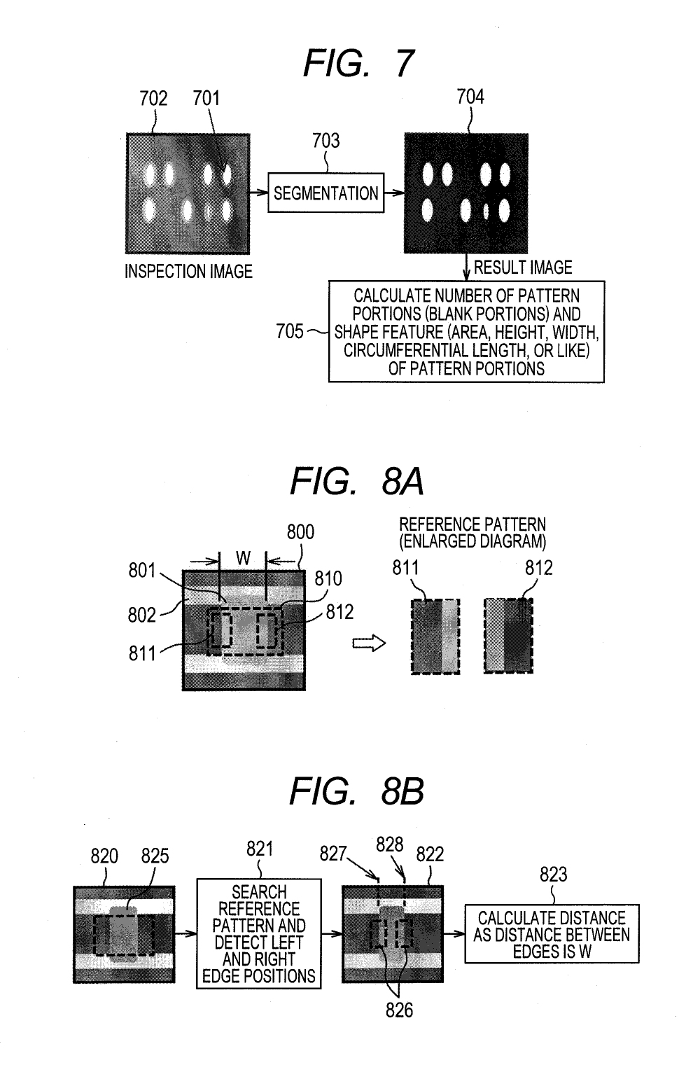

Next, FIG. 7 illustrates the content of the segmentation method. The segmentation process is a process that inspection subject images are sorted (segmented) into some groups according to a certain criteria. For example, a process that an inspection image is separated (segmented) into circuit pattern portions and the other portions (a base, for example) is a process that the pixels of an input image are determined as patterns or the other portions. FIG. 7 takes an example of an inspection image 702 of a hole pattern 701 that this image is separated into a base portion and pattern portions (segmentation: 703) and hole portions are blank and the other portions are dark on a result image 704. The number of blank portions and the shape feature of blank portions such as areas, vertical and horizontal dimensions, and circumferential length, for example, in the result image are then calculated to obtain defect information 705. It is noted that in this example, the case is schematically illustrated where hole portions are brighter than a base portion. This segmentation can be easily performed using the brightness values of pixels. However, it is difficult to perform segmentation using only brightness information about the image depending on how patterns are seen, and there might be the case where more complex processing algorithms are necessary.

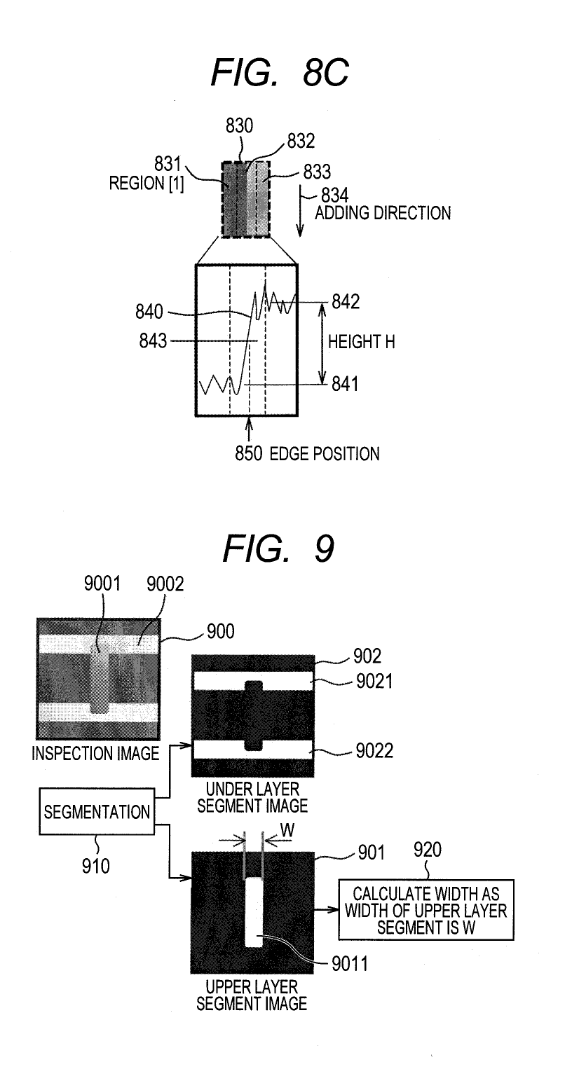

FIGS. 8A to 8C illustrate the content of the pattern matching method. Here, an example will be described that the measurement of the wiring width (W) of an upper layer pattern 801 is defined on an inspection image 800 (a template in FIGS. 8A to 8C) where circuit patterns of the upper layer pattern 801 and an under layer pattern 802 are observed and inspection is performed according to the content of the pattern matching method. FIG. 8A illustrates a reference pattern registered in a presetting process performed prior to inspection. This example represents that two rectangular regions 811 and 812 including the right and left end portions of the upper layer pattern 801 are selected as reference patterns from the inside of a measurement subject region 810 on the template 800.

FIG. 8B is a process flow up to extracting defect information from an inspection image by the pattern matching method. First, an inspection image 820 is aligned with the template 800. The position of the measurement subject region 810 is detected on the inspection image. After that, the registered reference pattern is searched 821 in a measurement processed region 825 on the inspection image 820. For this search, a typical normalized cross-correlation method, for example, is used for the image matching method. Search result positions 826 in FIG. 8B represent the positions of the two searched reference pattern 811 and 812. Edge position detection 822 is performed on the images of the searched regions, and W is calculated 823 as a distance between obtained two edge positions 827 and 828.

As illustrated in FIG. 8C, in the edge position detection method, a reference pattern 830, for example, is divided into three regions, a left region 831 [1], a middle region 832 [2], and a right region 833 [3], along a pattern direction. A signal waveform 840 is then calculated, in which the pixel values of a region where the reference pattern 830 is searched is added and averaged along a circuit pattern direction 834, to calculate average intensities 841 and 842 in the regions [1] and [3], respectively. A ratio to a difference between the average intensities 841 and 842 (50%, for example) is defined, and a position 843, at which the intensity value of a profile in the region [2] becomes this ratio, is set to an edge position. When edge position detection according to this method is performed at the search positions of the two reference patterns 811 and 812, edge positions 850 at the right and left of the pattern are identified. Thus, a distance between the edge positions 850 is found to calculate a targeted upper layer pattern width W.

As described above, the outline of the three methods, comparison inspection, segmentation, and pattern matching, are described. In the explanation above, it is described that the three methods (comparison inspection, segmentation, and pattern matching) can implement three inspection items (defect determination, pattern shape analysis, and pattern measurement), respectively. However, it is noted that the methods and the inspection items do not always correspond to each other one to one.

For example, FIG. 9 illustrates the process flow of implementing an inspection item using segmentation, not pattern matching, in the case where the inspection item is the pattern measurement of an upper layer pattern. It is already described that the segmentation process is a process of separating the pixels of an inspection image into a plurality of groups. In a multi-layer pattern as in this example, it is equivalent to sorting pixels into three groups, a base, an under layer pattern, and an upper layer pattern. FIG. 9 illustrates an example that an upper layer segment image 901 and an under layer segment image 902 are extracted from an inspection image 900 in a region including an upper layer pattern 9001 and an under layer pattern 9002 by a segmentation process 910 using pattern brightness, meaning circuit patterns that blank portions 9011, 9021, and 9022 are separated in the segment images. In FIG. 9, when attention is focused on the upper layer segment image 901 for calculation 920 as the width (the average width) of the recognized segment (the blank portion) 9011 is W, pattern measurement, which is the inspection item, can be implemented.

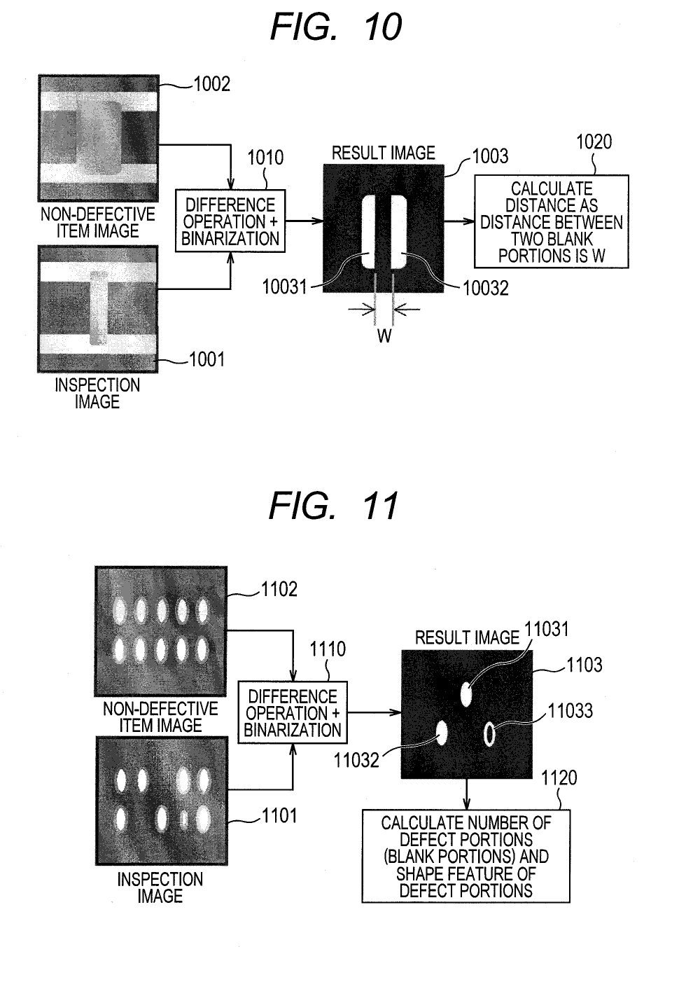

Moreover, FIG. 10 illustrates an example that the same inspection item (pattern measurement) is performed using the image comparison method. A result image 1003 in this example shows a result that a differential image is calculated from an inspection image 1001 and a non-defective item image 1002, and binarization 1010 is performed on the calculated differential image. Blank portions 10031 and 10032 in this result image 1003 are portions with a difference between the inspection image 1001 and the non-defective item image 1002. When a distance (an average distance) between these two blank regions 10031 and 10032 is calculated on this image, the pattern width W of an upper layer, which is the inspection item, can be calculated 1020.

For another example, FIG. 11 illustrates an example that pattern shape analysis is performed using the image comparison method, not the segmentation method. When an inspection image 1101 is compared with a non-defective item image 1102 to perform the arithmetic operation of a differential image and a binarization process 1110, locations at which faulty shapes occur can be extracted on patterns in the inspection image (blank portions 11031 to 11033 on a result image 1103). Index values of shape features such as the number of the blank regions 11031 to 11033 and the areas and width of the blank portions are calculated 1120 in the result image 1103, and thus pattern shapes can be analyzed.

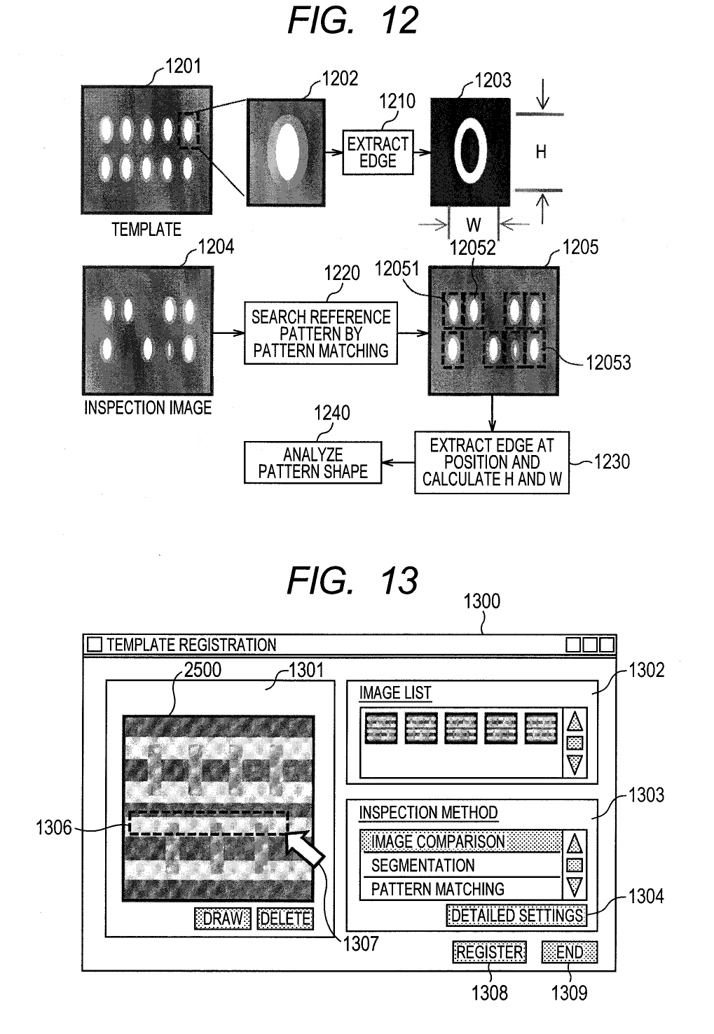

Furthermore, FIG. 12 illustrates an example that pattern shape analysis is performed using the pattern matching method. A reference pattern 1202 (an elliptic hole pattern, here) cut from a template 1201 is registered beforehand, an edge extraction process 1210 is performed on this image, and index values such as a height H and a width W of a hole are extracted from a result image 1203 and registered. Then, a pattern which is matched or similar to the reference pattern 1202 is searched 1220 from an inspection image 1204 by pattern matching. From an inspection image 1205 in which search regions 12051, 12052 to 1205n are set, the registered index values (H and W) are calculated 1230 from the edge extraction result in the set search regions. Subsequently, pattern shape analysis 1240 is performed using the number of search results and index values (the values H, W, and so on) at search positions in this inspection image.

From some cases illustrated so far, it is revealed that applicable inspection methods are not always one method to a necessary inspection item and some methods are applicable in some cases. Now again referring to the process flow illustrated in FIG. 1. The subsequent process step is to select an inspection method to be applied to the regions defined on the template (S105) ((b), (c), and (d) of FIG. 18). The inspection items are individually determined for the inspection regions (in this example, pattern measurement for the regions 1811 to 1814 in (b) of FIG. 18, defect determination for the regions 1821 to 1824 in (c) of FIG. 18, and pattern shift measurement for the regions 1831 to 1834 in (d) of FIG. 18). However, which inspection method is applied to which inspection item is determined from the observation of the actual SEM images and the results of the image processing.

In the schematic diagrams illustrating the SEM images used in the explanation so far, a circuit pattern is to have uniform gray scale values. However, in actual SEM images, there are various ways to see a circuit pattern depending on the material, for example, of the circuit pattern. Which one is brighter between a base and a pattern can be changed depending on the materials. In some cases, only the boundary of the pattern is detected as bright (a so-called edge effect), and inside and outside of the pattern are the same in brightness. Therefore, which one of the methods is effective for the targeted inspection item is determined by the observation of the result of some processes actually tried.

Setting the inspection region on the template (S104) and setting the inspection method (S105) described so far are performed through the input/output terminal 222. Exemplary display screens and operation procedures for the settings will be described with reference to FIGS. 13 to 16.

FIG. 13 is an exemplary display screen 1300 in setting an inspection region on a template. The display screen 1300 includes main components as an image list display area 1302 on which a list of collected image groups is displayed, the list being read from the inspection image storage unit 217, a template display area 1301 that displays a template 1305 and sets an inspection region on the template 1305, and an inspection method setting area 1303 that selects an inspection method. When a given image is selected as the template 1305 from the image list display area 1302, the image is displayed on the template display area 1301. On the screen on which this template 1305 is displayed, an inspection region 1306 is drawn in a rectangle, for example, on the template 1305 with a pointer 1307 using an input device such as a mouse. An inspection method is selected for the region 1306 from a menu displayed on the inspection method setting area 1303. Repeating the defining of the inspection region 1306 at the template display area 1301 and selecting of an inspection method at the inspection method setting area 1303, any number of inspection regions are defined. When setting the inspection region 1306 and the inspection method for the inspection region 1306 on the inspection method setting unit 1303 are finished, and clicking a registration button 1308 on the screen 1300, the set information is stored in the inspection condition storage unit 216.

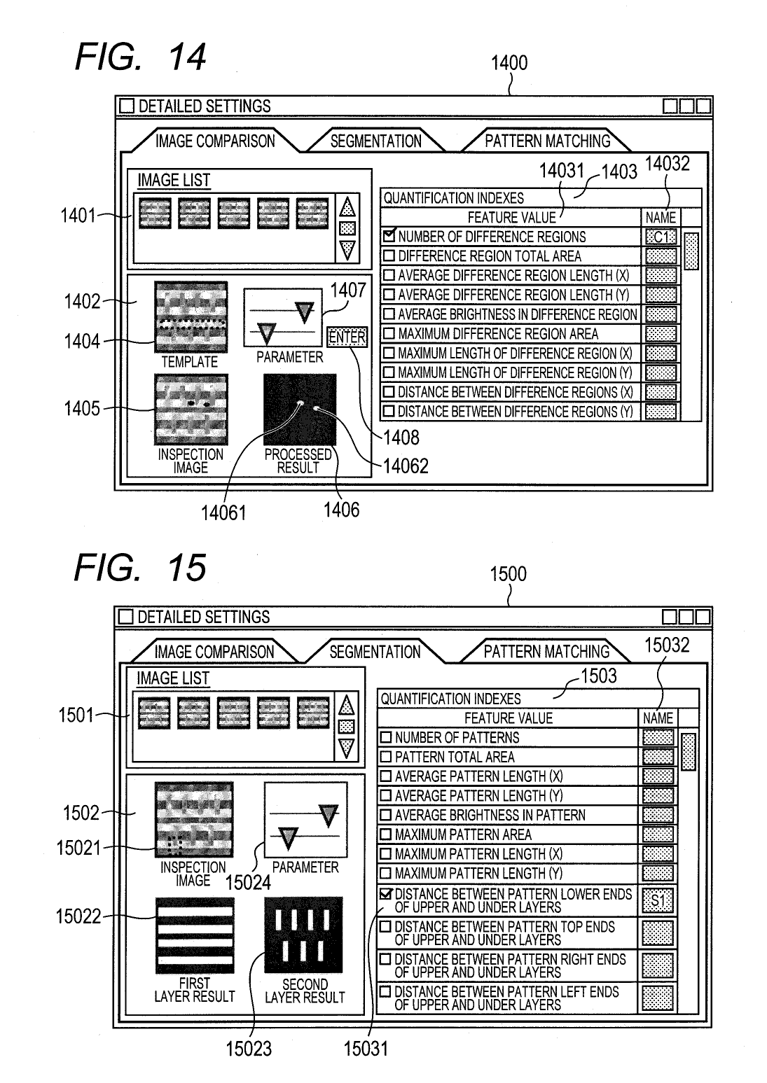

FIGS. 14 to 16 are screens to set process parameters for the inspection methods and output feature values (quantification indexes). These screens are called by clicking a detail setting button 1304 on FIG. 13.

FIG. 14 is an exemplary detail setting screen 1400 for the image comparison method. The detail setting screen 1400 includes main components as an image list display area 1401 that displays a list of collected image groups, a processed result display area 1402 that displays the intermediate results of comparison and adjusts parameters, and an index defining area 1403 that defines quantitative index values to be outputted.

For detailed settings in image comparison, an inspection image, which is to be compared with the template registered on the screen 1300 in FIG. 13, is selected from images displayed on the image list display area 1401. A template image 1404, an inspection image 1405, and a compared result 1406 of these two images are then displayed on the processed result display area 1402. In this processing, for example, the process is tried while changing parameters such as a binarization threshold for the differential image using a parameter setting area 1407, and parameters suited for the process are determined. An enter button 1408 is clicked to compare the template image 1404 with the inspection image 1405 using the set parameters, and then the differential image can be acquired as the image of the processed result 1406.

The quantitative index defining area 1403 has a function to define what quantitative index is calculated from a difference region obtained from the result of image comparison (regions displayed as blank elliptic regions 14061 and 14062 in the result image 1406). In the index defining unit 1403, a list of feature values 14031 registered beforehand (the number of difference regions, the total area of difference regions, and so on) is displayed, and an index used for output is selected and marked. In this marking, a name 14032 can be individually assigned to the feature values, and this name 14032 is used as in displaying the processed result. FIG. 14 illustrates an example that a name C1 in the column of the name 14032 is assigned to a feature value of the number of difference regions in the feature value column 14031.

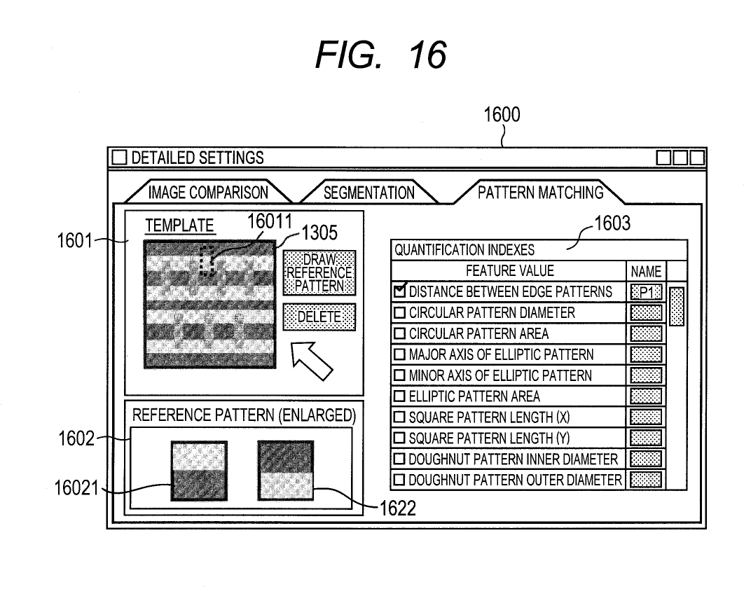

FIGS. 15 and 16 are detail setting screens similar to each other for the segmentation method and the pattern matching method. When segmentation is selected at the inspection method setting area 1303 on the screen 1300 illustrated in FIG. 13 and the detail setting button 1304 is clicked, or when a segmentation tub is clicked on the detail setting screen 1400 in FIG. 14, a detail setting screen 1500 for the segmentation method as FIG. 15 is displayed. Moreover, when pattern matching is selected at the inspection method setting area 1303 on the screen 1300 illustrated in FIG. 13 and the detail setting button 1304 is clicked, or when a pattern matching tub is clicked on the detail setting screen 1400 in FIG. 14, the detail setting screen 1500 for the pattern matching method in FIG. 16 is displayed.

First, the case will be described where the segmentation method is selected with reference to FIG. 15. The detail setting screen 1500 for the segmentation method in FIG. 15 includes main components as an image list display area 1501 that displays a list of collected image groups, a processed result display area 1502 that displays the result of comparison, and an index defining area 1503 that defines quantitative index values. It is possible that an image is selected from a plurality of images displayed on the image list display area 1501, the segmentation process is performed on this image while adjusting parameters, and the result is confirmed while displaying the result on the processed result display area 1502. On the processed result display area 1502, an inspection image 15021, a first layer image 15022, and a second layer image 15023 extracted from the inspection image 15021 by the segmentation process, and parameters 15024 for the segmentation process are displayed. A list of feature values 15031 is displayed as quantification indexes on the index defining area 1503, and a name 15032 can be set to a selected feature value on the index defining area 1503. Here, for the feature value corresponding to (c) of FIG. 18, a feature value 15031 is defined as a pattern shift value which is a distance between the lower ends of segmentation patterns in upper and under layers, and a name S1 is assigned to the column of the name 15032.

On the other hand, in the case where the pattern matching method is selected, a pattern matching method setting screen 1600 in FIG. 16 is displayed. The pattern matching method setting screen 1600 in FIG. 16 includes main components as a reference pattern registering area 1601, an enlarged reference pattern display area 1602, and an index defining area 1603 that defines quantitative index values.

The template 1305 set on the screen in FIG. 13 is displayed on the reference pattern registering unit 1601 of the pattern matching method setting screen 1600 for the pattern matching method, a partial region 16011 is selected on the template 1305, and the partial region 16011 is registered as reference patterns 16021 and 16022. The registered reference patterns 16021 and 16022 can be confirmed at the reference pattern display area 1602. Feature values to be outputted are set at the index defining area 1603. In this example, an example is shown that a distance between edge patterns is registered as a name P1.

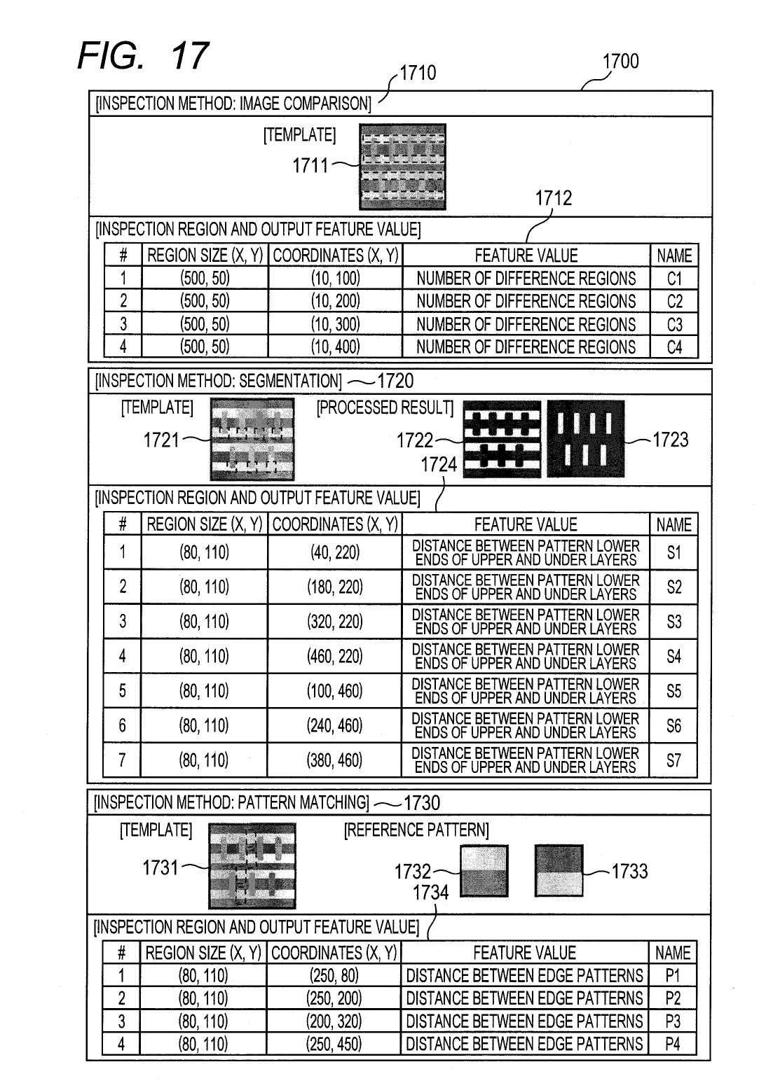

When information such as the inspection method, process parameters, and output quantitative indexes for the inspection regions as illustrated in (b), (c), and (d) of FIG. 18 are set on the exemplary screens illustrated in FIGS. 13 to 16. The items of information (in other words, information about a template, inspection regions, and the inspection method) are stored in the inspection condition storage unit 216 in the inspection information storage unit 215. FIG. 17 illustrates the table formats of data of inspection conditions stored for the inspection items illustrated in FIG. 18. FIG. 17 illustrates exemplary displays 1700 that individually arrange inspection conditions for the inspection methods. In an example that inspection conditions are arranged for an image comparison method 1710, a column 1712 showing a template image 1711, the size of an inspection region, the position (coordinates) of the template, and additional information such as types and names of output feature values (indexes) is displayed. In an example that inspection conditions are arranged for a segmentation method 1720, a column 1724 showing a template image 1721, segmentation result images 1722 and 1723, the size of an inspection region, the position (coordinates) of the template, and additional information such as types and names of output feature values (indexes) is displayed. Moreover, in an example that inspection conditions are arranged for a pattern matching method 1730, a column 1734 showing a template image 1731, reference pattern images 1732 and 1733, the size of an inspection region, the position (coordinates) of the template, and additional information such as types and names of output feature values (indexes) is displayed. Although not illustrated in FIG. 17, all of various items of condition data necessary to perform inspection such as process parameters in the processing methods are included in this information. These items of information are displayed and modified, for example, through the input/output terminal 222, as necessary.

The process steps S101 to S105 in the process flow in FIG. 1 described so far are pre-processing for inspection.

Next, the inspection process is performed. Since the inspection SEM image of the subject wafer is already acquired in S102 and stored in the inspection image storage unit 217, in the inspection process, inspection is repeated in which images are selected one by one from the image inspection groups stored in the inspection image storage unit 217. First, an inspection image is selected from image groups stored in the inspection image storage unit 217 (S106). Subsequently, template information, for example, corresponding to the inspection image selected in S106 is acquired from information stored in the inspection condition storage unit 216 (S107).

More specifically, the inspection image presently selected and information about the inspection conditions of the template image or the like for this inspection image are read out from the inspection image storage unit 217 and the inspection condition storage unit 216, respectively, and transferred to the arithmetic operation processing unit 219. It is noted that in this embodiment, it is assumed that an inspection portion in one chip is one location. However, in the case where a plurality of inspection portions exist in one chip, or in the case where inspection information is set to a wafer under a plurality of process steps, in this case, inspection information about the present inspection subject is selectively read in reading inspection conditions because a plurality of items of inspection information are stored in the inspection condition storage unit 216. Selective reading can be performed using ID numbers assigned to subject wafers and inspection coordinates in a chip as keys.

In this explanation, suppose that (a) of FIG. 19 is an inspection image 1900, and (a) of FIG. 18 is a corresponding template image 1800. The inspection image 1900 illustrated in (a) of FIG. 19 schematically depicts the case where imaging positions are slightly shifted with respect to the template image 1800 in (a) of FIG. 18, three defects 1903, 1904, and 1905 exist on wiring patterns, an under layer pattern 1902 is narrowed, and positions between an upper layer pattern 1901 and the under layer pattern 1902 are shifted. It is noted that the shift between the imaging positions of the inspection image 1900 and the template image 1800 means that imaging positions are sometimes shifted between images taken at the same location in different chips due to the influence of the accuracy of the movable stage 210 to stop in imaging (the order of a few micrometers in the general case).

Subsequently, the inspection image 1900 is aligned with the template image 1800, and an inspection region in the inspection image 1900 is identified (S108). This is a process in which alignment is performed to calculate a shift value between the imaging positions of the inspection image 1900 and the template image 1800, and the calculated shift value is added to location information about the partial regions set in the template image 1800 (the regions 1811 to 1814 in (b) of FIG. 18, the regions 1821 to 1824 in (c) of FIG. 18, and the regions 1831 to 1837 in (d) of FIG. 18) for identifying the positions of inspection regions on the inspection image 1900 (regions 1911 to 1914 in (b) of FIG. 19, regions 1921 to 1924 in (c) of FIG. 19, and regions 1931 to 937 in (d) of FIG. 19. Alignment can be implemented using the image matching method such as a normalized cross-correlation method. In FIG. 19, (b), (c), and (d) illustrate the identified inspection regions on the inspection image 1900 (the regions 1911 to 1914 in (b) of FIG. 19, the regions 1921 to 1924 in (c) of FIG. 19, and the regions 1931 to 937 in (d) of FIG. 19) for display as the regions are separated according to the pattern matching process, the image comparison process, and the segmentation process. After that, the inspection process is performed in the inspection regions according to the set inspection method (S109). This process is repeated for all the acquired images stored in the inspection image storage unit 217 (S110). When all the acquired images are processed, the inspected results are stored in the inspected result storage unit 218 (S111).

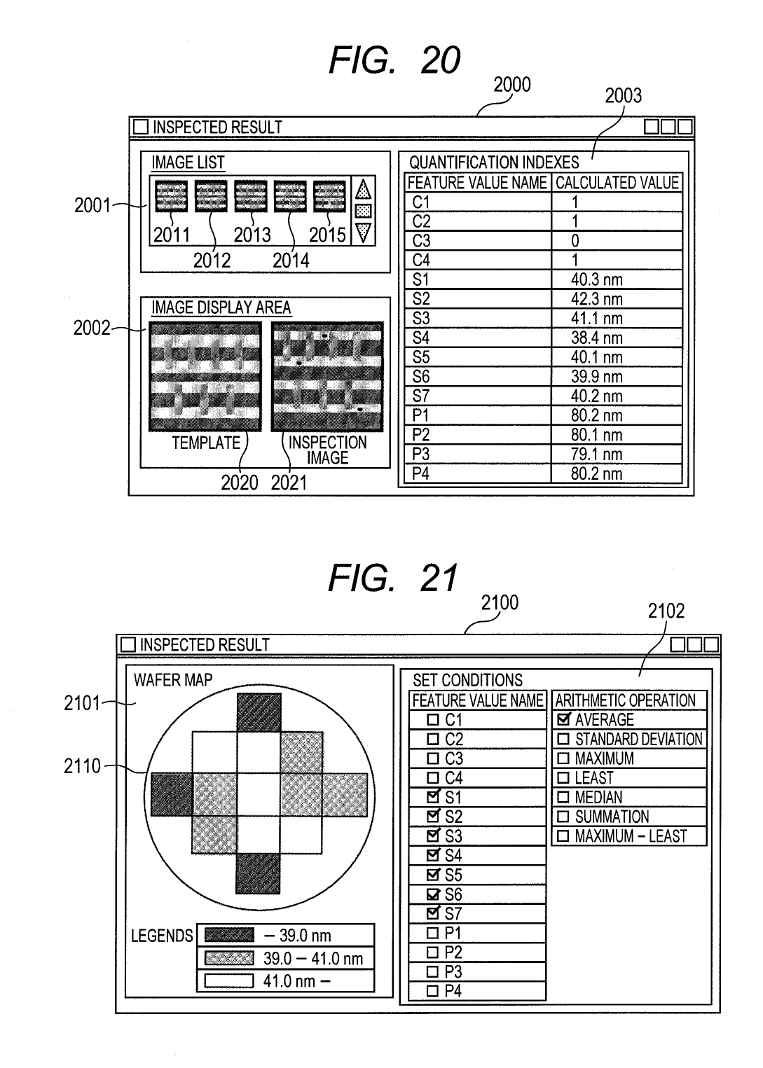

FIG. 20 and FIG. 21 are exemplary screens when displaying the inspected results stored in the inspected result storage unit 218 on the input/output terminal 222. FIG. 20 is an exemplary screen 2000 on which the inspected result of a single inspection image is displayed. The screen 2000 is configured to include an image list display area 2001, an image display area 2002, and a quantification index display area 2003. In the image list display area 2001, inspection image groups 2011 to 2015 are displayed in thumbnails. A single inspection image 2021 freely selected therefrom is displayed in the image display area 2002 together with a template image 2020 for the inspection image 2021. In the quantification index display area 2003, a list of the calculated values of all of feature values (C1 to C4, S1 to S7, and P1 to P4) defined on this template image 2020 is displayed. Moreover, although not illustrated in FIG. 20, the intermediate processed result can also be confirmed as well as the final feature values if the processed result is displayed for every processing method (in this example, comparison inspection, segmentation, and pattern matching).

FIG. 21 is an exemplary screen 2100 on which the inspected result is displayed for all the acquired inspection image groups. The screen 2100 includes components as a wafer map display area 2101 and a condition setting area 2102. Since inspection images are acquired from a chip on a wafer set beforehand, feature values obtained from the inspection images are statistically processed and mapped on a wafer map 2110, and thus, the tendency of defect positions can be observed. In the condition setting area 2102, a plurality of feature values used for displaying the wafer map can be selected from the calculated feature values, and an arithmetic operation method for the feature values can be selected (such as average, and standard deviation). A single quantitative index is calculated for the inspection images from the selected result of the feature value and the arithmetic operation method. Thus, if the size of the value of this quantitative index is expressed by the difference in brightness when displayed, for example, the distribution tendency of a wafer when defects occur can be intuitively grasped from the difference between the brightness of chips as illustrated in the wafer map 2110.

As described above, in this embodiment, the inspection method and the inspection apparatus used therefor are described in which a template is created from image groups collected from a wafer, an inspection region and a method are set on the template, and images in the image groups are processed according to the content of the method.

### Second Embodiment

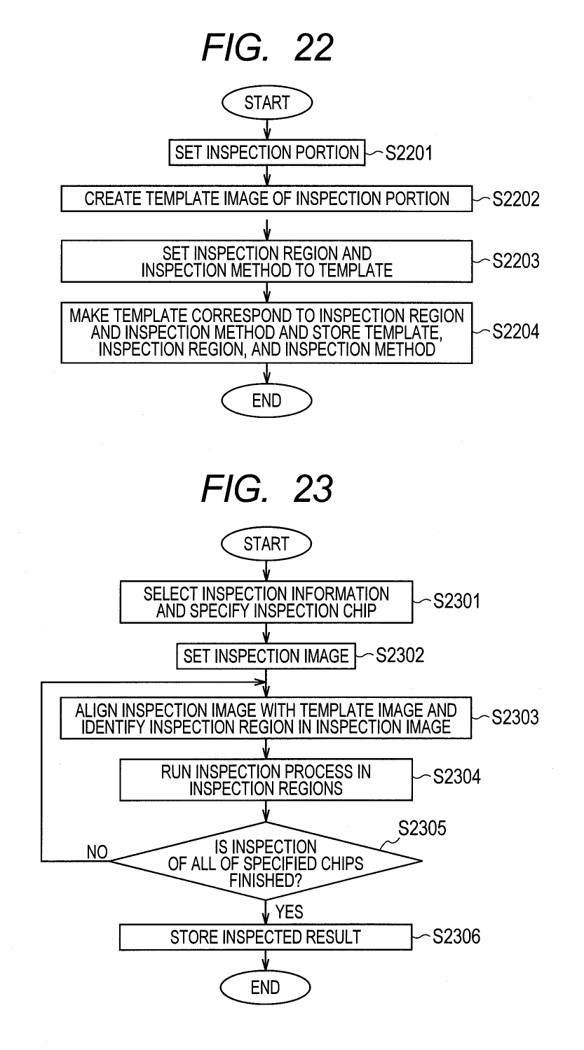

The process flow of a defect inspection method according to a second embodiment of the present invention will be described with reference to FIGS. 22 and 23. In the first embodiment described above, an example is described in which inspection images are collected from a sample wafer, a template is created and inspection information is set using the images, and an inspection process is performed on image groups already acquired using the result. In the second embodiment described here, a process flow will be described in assuming the case where a sample wafer for creating a template is different from an inspection wafer. The first embodiment is different from the second embodiment in the process flow. Many of individual process steps in the second embodiment are the same as the process steps of the first embodiment. Therefore, for process steps in the second embodiment substantially similarly performed as in the first embodiment, the detailed description is omitted in the description below unless otherwise specified.

In the second embodiment, there are two process flows, a pre-process performed prior to inspection and an inspection process. FIG. 22 illustrates the flow of the pre-process. First, an inspection portion is set in the chip (S2201). This setting is made by a user to pick up a region to be inspected from a chip layout. The process similar to setting the inspection portion in S101 in the first embodiment described with reference to FIG. 1 is performed. Subsequently, a template image in this inspection portion is created (S2202). More specifically, a wafer formed with patterns is prepared, and a predetermined inspection portion on this wafer is imaged using the SEM 201 for a template image. In this processing, since a plurality of chips having the same patterns are formed on the wafer, it is necessary to specify that the image of the inspection portion of which one of the chips be acquired. To this end, one chip (a chip close to the wafer center part, for example) may be specified, for example. Moreover, in addition to this, a plurality of chips may be specified on a wafer to create one image from a plurality of taken images using an image averaging process, for example.

Subsequently, inspection regions are set on the created template image and the inspection method is set to the regions (S2203). The template image is then associated with the positions of the inspection regions set on the template and the names of feature values to be extracted from the processed result, and they are stored in the inspection condition storage unit 216 (S2204). The procedures of registering information about the template, the operation of the components of the defect inspection apparatus, and exemplary screen display described above are the same as in the first embodiment. This is the flow of the pre-process.

Next, FIG. 23 illustrates the flow of an inspection process using the set inspection information. First, an inspection wafer is prepared and placed on the movable stage 210 of the SEM 201, and inspection information about this wafer and an inspection chip on this wafer are specified (S2301). Inspection information means information about the template image created in the pre-process illustrated in the flow in FIG. 22 and the inspection regions and the inspection method in association therewith, and so on. Specifying this inspection information is implemented by an operator to read information stored in the inspection condition storage unit 216 through the input/output terminal 222. The locations of chips to be inspected are specified by the operator to select any number of chips for inspection chips among chips on the wafer through the input/output terminal 222. Information about the locations of the specified chips is stored in the recipe 211.

Subsequently, the SEM control unit 204 controls the movable stage 210 and the electro-optic system 2071 based on location information about the inspection portions described in inspection information about the specified inspection chips to take SEM images of the inspection chips (S2302) in turn. The acquired images are temporarily stored in the image memory 212, and stored in the inspection image storage unit 217 in the inspection unit 214 through the communicating unit 213. After that, the arithmetic operation processing unit 219 performs the inspection process on the inspection images. More specifically, first, the inspection image is aligned with the template included in inspection information, and the positions of the inspection regions in the inspection image are identified (S2303). In the identified inspection region, processing is then performed using the inspection method registered in association with the template (S2304).

The processes in S2303 and S2304 are repeatedly performed on all the inspection chips that are specified in Step S2301, imaged in S2302, and stored in the inspection image storage unit 217 (S2305), and the processed result is stored in the inspected result storage unit 218 (S2305). A series of the processes through from S2302 to S2304 is performed at the arithmetic operation processing unit 219. The content of the processes in S2303 and S2304 is the same as the processes in S108 and S109 in the process flow in FIG. 1 described in the first embodiment.

In the inspection process sequence illustrated in FIG. 23, all of the inspection images are imaged from the inspection subject chips, and then the inspection process is performed on the inspection images. However, the inspection process sequence is not limited thereto. For example, such a process flow is also implemented in which images are taken in parallel with performing the inspection process if the inspection process is performed every time when finishing taking the images of a single subject chip.

### Third Embodiment

In the following, a third embodiment of the present invention will be described. In the second embodiment, the inspection method is described in which the template image is created in the same visual field size as the visual field size in imaging at inspection, and a plurality of inspection regions are set in the template image. In other words, in this inspection method, only partial regions in the visual field of the inspection image acquired in inspection are subjected to processing. In this case, in the case where the area of the inspection region is smaller than the area of the template image, most of image data in the acquired inspection images is not used for inspection. The smaller the ratio of the inspection region becomes, the more increased regions not processed are in a taken image. Particularly, in the case where the number of pixels of the acquired image is large (in other words, in the case of a high definition image), taking the images of regions not processed, time to transfer images, capacity in storage, and the like are wasted. An object of the third embodiment is to eliminate this waste.

To this end, in this embodiment, the visual field size of the template and the visual field size of the inspection image are made separately set in the step of creating the template image of the inspection portion (S2202) in the process flow of creating the template image illustrated in FIG. 22. More specifically, the template is provided with a relatively wide visual field size (a few micrometers), and a plurality of inspection regions are included in the visual field. In this processing, in order to allow the alignment of the inspection regions, the template is to be created so as to include an alignment pattern in the visual field. It is necessary that the alignment pattern be a unique pattern in the X- and Y-directions in order to allow the alignment of the image in the X- and Y-directions.

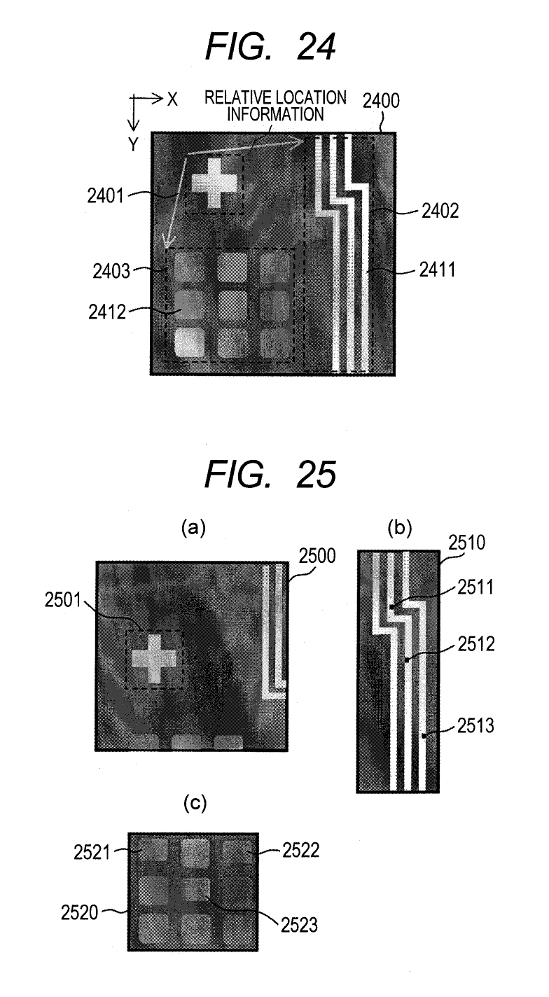

FIG. 24 is an exemplary template like this. FIG. 24 illustrates an example that there are an alignment pattern 2401, an inspection region (1) 2402 where a defect is determined, and an inspection region (2) 2403 where a pattern shape is analyzed in the visual field of a template image 2400. The inspection region (1) 2402 is a rectangular region including vertical line patterns 2411, and the inspection region (2) 2403 is a rectangular region including nine square patterns 2412. Regarding to these two inspection regions, information about the relative position relationship from the alignment pattern 2401 is added as inspection conditions in addition to the size of the regions in the X-and Y-directions. Moreover, the image of the alignment pattern 2401 is also added to inspection conditions. The inspection method is then individually defined to the inspection regions as similar to the first and second embodiments. All the items of information are associated with the template image 2400 and registered in the inspection condition storage unit 219.

Subsequently, in performing inspection corresponding to the process flow described in FIG. 23, images are taken only in the inspection regions, not acquiring images in the same visual field size as the visual field size of the template image in acquiring inspection images as described in the second embodiment. The inspection process is performed on the images of the inspection regions using the inspection method associated with the template image and stored in the inspection condition storage unit 219. It is noted that in acquiring the inspection image, it is necessary to consider the position shift of the imaging positions of the inspection regions caused by the influence of the accuracy of the movable stage 210 to stop. Therefore, prior to imaging the inspection region, first, only a region around an alignment pattern 2501 is imaged to acquire an image 2500, and the position of the alignment pattern 2501 is detected from this image 2500. FIG. 25(a) is an example of the image 2500 around the imaged alignment pattern 2501. The image matching process is performed between this image 2500 and the image of the alignment pattern 2401 stored in the inspection condition storage unit 219 to detect the position of the alignment pattern. With reference to the detected position, an image is taken at the position shifted from the alignment pattern 2501 already registered by the relative position of each inspection region, and thus it is possible to take the images of the inspection regions with no position shift.

An image 2510 in (b) of FIG. 25 and an image 2520 in (c) of FIG. 25 illustrate the images of inspection regions (1) and (2), respectively (each regions have defects). The inspection process is performed on the images 2510 and 2520 of these inspection regions by the inspection method set in S2203 in FIG. 22, and defect determination and pattern shape analysis are performed on the images 2510 and 2520. In the case of (b) in FIG. 25, defects 2511, 2512, and 2513 are extracted from the image 2510 of the inspection region (1). In the case of (c) in FIG. 25, faulty dimension patterns 2521, 2522, and 2523 are extracted from the image 2520 of the inspection region (2).

Since the methods of outputting and displaying the inspected result are the same as the methods described in the first embodiment, the description is omitted.

As described above, the specific embodiments of the defect inspection method and the defect inspection apparatus according to the present invention are described. In the present invention, a plurality of inspection regions are set on a template, and an inspection method and an output index are set in association with the individual regions. Inspection is performed based on information set to the template.

In the present invention, it is possible to easily modify inspection conditions by changing information set to the template. Thus, it is possible to easily add and modify inspection items even in the case where it is revealed that a desired defect is not detected in the consequence of inspecting the collected inspection images under certain conditions to confirm the result, or in the case where a necessity occurs to newly add an inspection item for inspection.

According to the present invention, it is expected to efficiently operate inspection process steps such as confirming the inspection process and the result and modifying inspection conditions and items in the consequence of the result, for example, in the process developing stage in which it is uncertain that what defect mode occurs.

### INDUSTRIAL APPLICABILITY

The present invention is applicable to a defect to inspection method and an inspection apparatus that inspect various defects occurring in the manufacturing process steps of semiconductor wafers or the like.

### REFERENCE SIGNS LIST

201 SEM
202 Electro-optic system column
203 Storage unit
204 SEM control unit
205 Input/output I/F
206 Input/output terminal
207 Electron source
208 Detector
209 Sample wafer
210 Movable stage
211 Recipe
212 Image memory
213 Communicating unit
214 Inspection unit
215 Inspection information storage unit
216 Inspection condition storage unit
217 Inspection image storage unit
218 Inspected result storage unit
219 Arithmetic operation processing unit
220 Unit controller
221 Input/output I/F
222 Input/output terminal
1301 Template display unit
1302 Image list display unit
1303 Inspection method setting unit
1304 Detail setting button
1305 Inspection region
1401 Image list display unit
1402 Processed result display unit
1403 Index defining unit
1501 Image list display unit
1502 Processed result display unit
1503 Index defining unit
1601 Reference pattern registering unit
1602 Reference pattern display unit
1603 Index defining unit
2001 Image list display unit
2002 Image display area
2003 Quantification index display unit
2101 Wafer map
2102 Condition setting unit

1. A defect inspection apparatus comprising:
a scanning electron microscope (SEM) unit;
a storage unit configured to store a plurality of SEM images acquired by sequentially imaging a plurality of regions set beforehand on a sample with the SEM unit;
a template image creating unit configured to create a template image using the SEM images stored in the storage unit;
an inspection condition setting unit configured to set and store an inspection region, an inspection method and an inspection item corresponding to the inspection region on the template image created at the template image creating unit;
an image aligning unit configured to select one SEM image from the plurality of SEM images stored in the storage unit to align the SEM image with the template image created at the template image creating unit;
an inspection region setting unit configured to set an inspection region on the SEM image aligned with the template image by the image aligning unit using information about the inspection region stored in the inspection condition setting unit; and
an image processing unit configured to process the SEM image of the inspection region set by the inspection region setting unit on the basis of the inspection method stored in the inspection condition setting unit for inspection based on the stored inspection item.

2. The defect inspection apparatus according to claim 1,
wherein the inspection condition setting unit sets an item related to an image feature value of the SEM image of the inspection region to be processed at the image processing unit for the inspection item.

3. The defect inspection apparatus according to claim 1,
wherein the template image creating unit creates the template image using the plurality of SEM images acquired by the SEM unit.

4. The defect inspection apparatus according to claim 1,
wherein the inspection method corresponding to the inspection region set at the inspection condition setting unit includes any one of an image inspection method, a pattern matching method, and a segmentation method.

5. A defect inspection apparatus comprising:
a scanning electron microscope (SEM) unit;
a template image creating unit configured to create a template image from an SEM image of a first sample acquired by imaging the first sample with the SEM unit;
an inspection condition setting unit configured to set and store an inspection region, an inspection method and an inspection item for the inspection region on the template image created at the template image creating unit;
an image aligning unit configured to align an SEM image of a second sample acquired by imaging the second sample by the SEM unit with the template image created at the template image creating unit;
an inspection region setting unit configured to set an inspection region on the SEM image aligned with the template image by the image aligning unit using information about the inspection region stored in the inspection condition setting unit; and
an image processing unit configured to process the SEM image of the inspection region set by the inspection region setting unit on the basis of the inspection method stored in the inspection condition setting unit for inspection based on the stored inspection item.

6. The defect inspection apparatus according to claim 5,
wherein the template image creating unit creates the template image using the plurality of SEM images acquired by the SEM unit.

7. The defect inspection apparatus according to claim 5,
wherein the inspection method corresponding to the inspection region set at the inspection condition setting unit includes any one of an image inspection method, a pattern matching method, and a segmentation method.

8. A defect inspection apparatus comprising:
a scanning electron microscope (SEM) unit;
an SEM image storage unit configured to store an SEM image of a sample acquired by imaging the sample with the scanning electron microscope (SEM) unit;
a template image storage unit configured to associate and store a template image with information about an inspection region of the template image, an inspection method and an inspection item for the inspection region;
an image aligning unit configured to align the SEM image stored in the SEM image storage unit with the template image stored in the template image storage unit;
an inspection region setting unit configured to set an inspection region on the SEM image aligned with the template image by the image aligning unit using inspection region information stored in the template image storage unit in association with the template image; and
an image processing unit configured to process the SEM image of the inspection region set by the inspection region setting unit on the basis of the inspection method stored in the template image storage unit to inspect the stored inspection item.

9. A defect inspection method comprising:
sequentially imaging a plurality of regions set beforehand on a sample using a scanning electron microscope (SEM) to acquire a plurality of SEM images for storage;
creating a template image using the stored SEM images;
setting and storing an inspection region, an inspection method and an inspection item corresponding to the inspection region on the created template image;
selecting one SEM image from the plurality of stored SEM images to align the SEM image with the created template image;
setting the inspection region set on the template image on the SEM image aligned with the template image; and
processing an image of the inspection region set on the SEM image on the basis of the stored inspection method for inspection based on the inspection item.

10. The defect inspection method according to claim 9,
wherein the template image is created using the plurality of stored SEM images.

11. The defect inspection method according to claim 9,
wherein in the step of setting and storing the inspection method and the inspection item for the inspection region, the inspection method to be set includes any one of an image comparison method, a pattern matching method, and a segmentation method.

12. A defect inspection method comprising:
imaging a first sample using a scanning electron microscope (SEM) to acquire an SEM image of the first sample;
creating a template image from the acquired SEM image;
setting and storing an inspection region, an inspection method and an inspection item for the inspection region on the created template image;
imaging a second sample using the scanning electron microscope (SEM) to acquire an SEM image of the second sample;
aligning the acquired second SEM image with the created template image;
setting an inspection region on the aligned second SEM image based on the template image; and
processing the SEM image of the set inspection region on the basis of the stored inspection method for inspection based on the inspection item.

13. The defect inspection method according to claim 12,
wherein the template image is created using a plurality of acquired SEM images of the first sample.

14. The defect inspection method according to claim 12,
wherein in the step of setting and storing the inspection region, the inspection method and the inspection item for the inspection region, the inspection method to be set includes any one of an image comparison method, a pattern matching method, and a segmentation method.

15. A defect inspection method comprising:
aligning an SEM image of a sample acquired by imaging the sample by using a scanning electron microscope (SEM) with a template image stored in a storage unit;
setting an inspection region on the aligned SEM image using inspection region information stored in association with the template image; and
processing the SEM image based on an inspection method selected from a plurality of inspection methods in association with inspection region information about the template image and an inspection item set in association with the inspection region information to inspect the set inspection region.

16. The defect inspection method according to claim 15,
wherein the template image is an image created by using the SEM image of the sample acquired by imaging the sample using the SEM.

17. The defect inspection method according to claim 15,
wherein the template image is an image created by using an SEM image of a different sample acquired by imaging the different sample using the SEM beforehand.
